(19) United States
(12) Patent Application Publication
(10) Pub. No.: US 2025/0239739 A1
(43) Pub. Date: Jul. 24, 2025

(54) BATTERY PACK

(71) Applicant: SAMSUNG SDI CO., LTD., Yongin-si (KR)

(72) Inventors: DAEYEOP PARK, Yongin-si (KR); NOHYUN KWAG, Yongin-si (KR); MINUK WOO, Yongin-si (KR); JEONGMIN LEE, Yongin-si (KR); SEOKBIN YOON, Yongin-si (KR); KUMYUL HWANG, Yongin-si (KR)

(21) Appl. No.: 18/971,410

(22) Filed: Dec. 6, 2024

(30) Foreign Application Priority Data
Jan. 19, 2024 (KR) 10-2024-0008934

(51) Int. Cl. H01M 50/505; H01M 50/227

(52) U.S. Cl. CPC H01M 50/505; H01M 50/227

(57) ABSTRACT

A battery pack is capable of suppressing over-heating of a bus bar or a battery cell in the battery pack by including an improved cell holder and bus bar structure. The bus bar electrically connects a plurality of battery cells and the cell holder fixing the bus bar. The cell holder is coupled to the bus bar as an insert-injection molded structure, and the bus bar includes a heat-conduction accelerating portion formed in a portion of the bus bar that is coupled to the cell holder.

### CROSS-REFERENCE TO RELATED APPLICATION

The present application claims priority and the benefit of Korean Patent Application No. 10-2024-0008934, filed on Jan. 19, 2024, in the Korean Intellectual Property Office, the entire disclosure of which is incorporated herein by reference in its entirety.

### BACKGROUND

### 1. Field

One or more embodiments relate to a battery pack, and more particularly, to a battery pack including a coupling structure of a bus bar and a cell holder.

### 2. Description of the Related Art

A secondary battery can be charged and discharged, unlike a primary battery that cannot be recharged. Low-capacity secondary batteries are used in small portable electronic devices such as smartphones, feature phones, laptop computers, digital cameras, and camcorders. High-capacity secondary batteries are used as motor-driving power sources, power-storing batteries, etc., in hybrid vehicles, electric vehicles, etc. Such secondary batteries may include an electrode assembly including a cathode and an anode, a case accommodating the electrode assembly, an electrode terminal connected to the electrode assembly, etc.

Generally, a battery pack can be used to store energy as an energy storage system (ESS) or in an electric vehicle (EV). The EV may include a hybrid electric vehicle (HEV), a plugin hybrid electric vehicle (PHEV), a battery electric vehicle (BEV), etc.

Due to capacity increase and high charging/discharging C-rate of the battery pack, heat emission of a bus bar and a battery cell in a battery pack can become a safety hazard. Therefore, heat management is important in the development of battery packs.

The above-described information serves as a background of the present disclosure and is only for improving the understanding the present disclosure, and, thus, may include information that does not constitute related art.

### SUMMARY

One or more embodiments include a battery pack capable of effectively dissipating heat generated by a bus bar and a battery cell, which are components of the battery pack, by improving a coupling structure of the bus bar and the cell holder.

However, technical problems to be solved by the present disclosure are not limited to the above-mentioned problem, and other problems not mentioned herein may be clearly understood by those of ordinary skill in the art from the description of the present disclosure.

Additional aspects will be set forth in part in the description which follows and will be apparent from the description, or may be learned by practice of the presented embodiments of the present disclosure.

According to one or more embodiments, a battery pack includes a bus bar electrically connecting a plurality of battery cells and a cell holder fixing the bus bar, in which the cell holder is coupled to the bus bar as an insert-injection molded structure, and the bus bar includes a thermal-conduction accelerating portion formed in a portion of the bus bar that is coupled to the cell holder.

The heat-conduction accelerating portion may be formed in an edge portion of the bus bar.

The heat-conduction accelerating portion may include an edge in a square pulse shaped edge.

The heat-conduction accelerating portion may include a plurality of holes extending between a bottom surface and a top surface of the bus bar.

The plurality of holes may be arranged in a line.

The plurality of holes may be arranged in a zigzag pattern.

The heat-conduction accelerating portion may include a sine wave shaped edge.

The cell holder may include a heat-dissipating plastic.

### BRIEF DESCRIPTION OF THE DRAWINGS

The above and other aspects, features, and advantages of certain embodiments of the present disclosure will be more apparent from the following description taken in conjunction with the accompanying drawings.

FIG. 1 shows a structure of a battery pack in which a cell holder and a bus bar are assembled, according to embodiments of the present disclosure;

FIG. 2 is an exploded perspective view of an assembly shown in FIG. 1 in which one bus bar is separated;

FIG. 3 is a cross-sectional view cut along a line III-III in FIG. 1;

FIG. 4 is a cross-sectional view cut along a line IV-IV in FIG. 1;

FIG. 5 shows an example of a structure of a bus bar in FIG. 1;

FIG. 6 shows another example corresponding to FIG. 5;

FIG. 7 shows another example corresponding to FIG. 5; and

FIG. 8 shows another example corresponding to FIG. 5.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items.

The terms and words used in the present specification and claims should not be construed as being limited to ordinary or dictionary meanings, and should be interpreted as meanings and concepts consistent with the technical idea of the present disclosure based on the principle that the present inventors may appropriately define the concept of the terms to describe their invention in the best way. Therefore, it should be understood that the configurations shown in the drawings and embodiments described in this specification are merely the most preferred embodiments of the present disclosure, and do not represent all of the technical ideas of the present disclosure, such that there may be various equivalents and variations that replace them at the time of filing the present application. If used herein, “comprise, include” and/or “comprising, including” specify mentioned shapes, numbers, steps, operations, members, components, and/or presence of these groups, and do not exclude the presence or addition of one or more different shapes, numbers, operations, members, components, and/or groups. If embodiments of the present disclosure are described, “can” or “may” may include “one or more embodiments of the present disclosure”.

To help understanding of the present disclosure, the accompanying drawings are not shown according to the actual scale, and the dimensions of some components may be exaggerated. The same reference numeral may be given to the same component in different embodiments.

The statement that two comparison targets are “the same” as each other may mean that they are ‘substantially the same’ as each other. Thus, a case where they are ‘substantially the same’ as each other may include a case where they have a deviation regarded as a low level, e.g., a deviation of 5% or less. If a uniform parameter is uniform in a predetermined area, it may mean that it is uniform from an average point of view.

Although 1st, 2nd, etc., may be used to describe various components, these components are not limited by these terms. These terms are only used to distinguish one component from other components, and unless specifically stated to the contrary, a first component may be a second component.

Throughout the specification, unless specially stated to the contrary, each component may be singular or plural.

If a component is arranged on “a top portion (or a bottom portion)” of another component or “on (or under)” the other component, it may mean not only a case where the component is arranged adjacent to a top surface (or a bottom surface) of the other component, but also a case where another component may be interposed between the other component and the component arranged on (or under) the other component.

When a component is described as being “connected”, “coupled”, or “connected” to another component, it should be understood that the components are directly connected or connectable to each other, but another component may be “interposed” between the components, or the components may be “connected”, “coupled”, or “connected” to each other through another component. If a portion is electrically coupled to another portion, this may include not only a case where they are directly connected to each other, but also a case where they are connected with another element therebetween.

Throughout the specification, “A and/or B” may mean A, B, or A and B unless specially stated otherwise. That is, “and/or” may include all or any combination of a plurality of items listed. “C to D” may mean at least C but not more than D, unless specially stated otherwise.

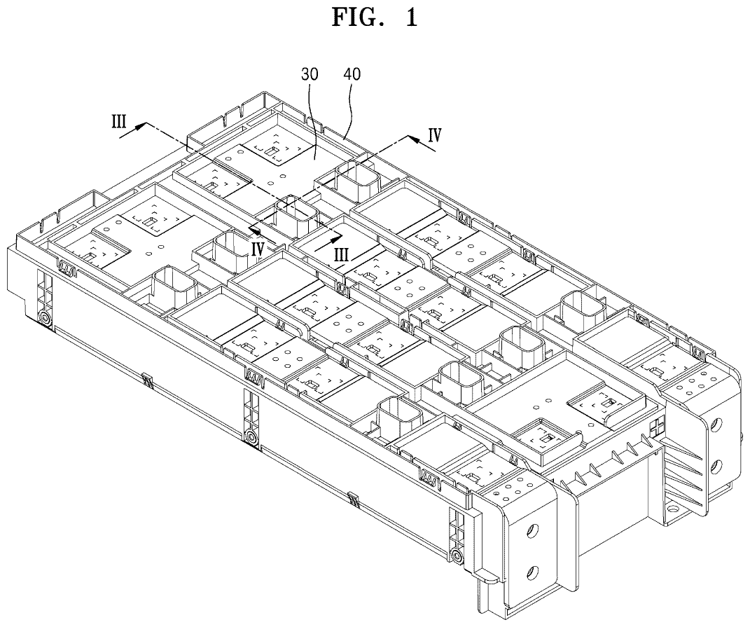

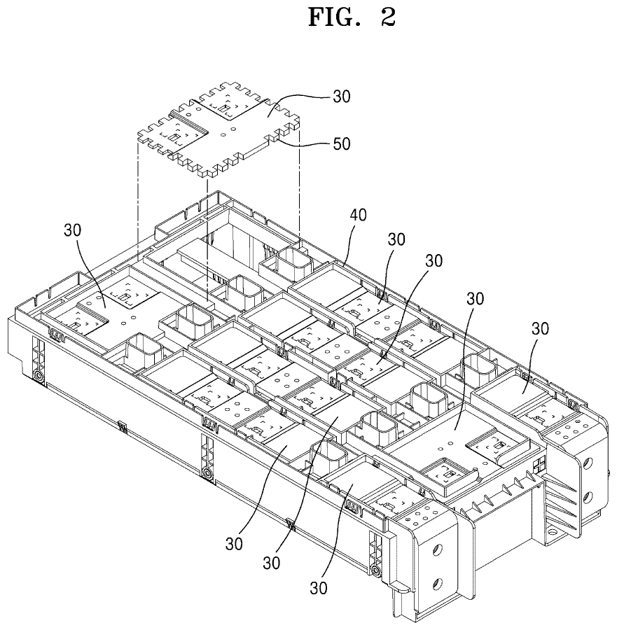

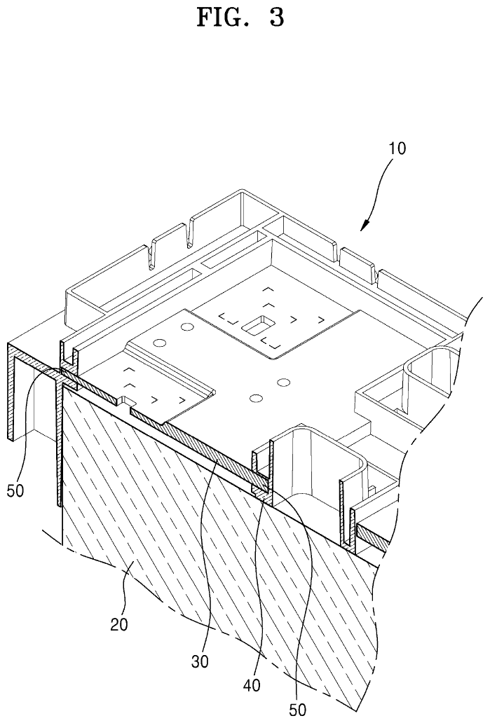

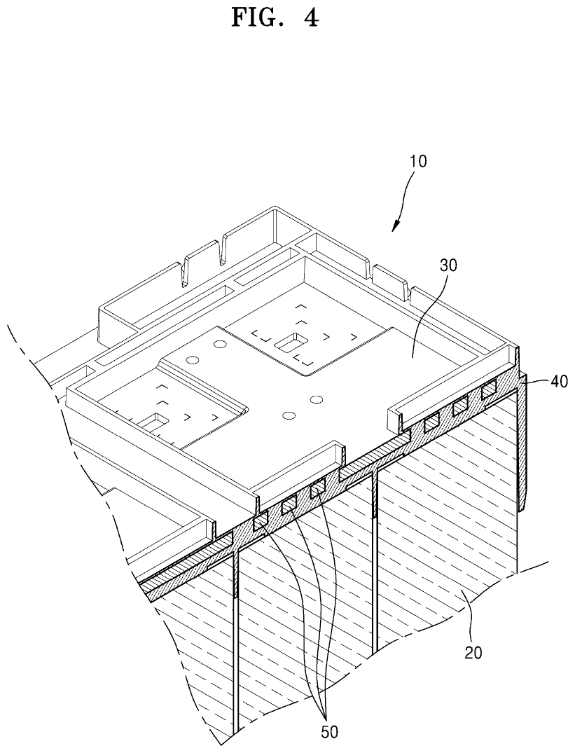

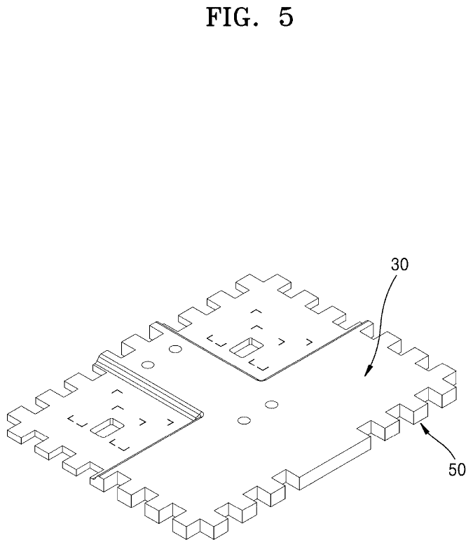

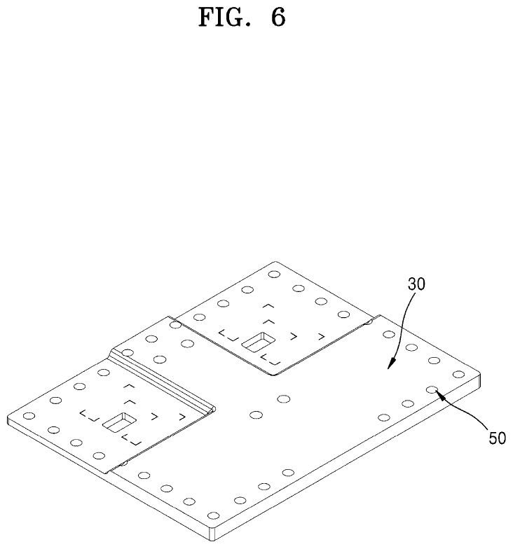

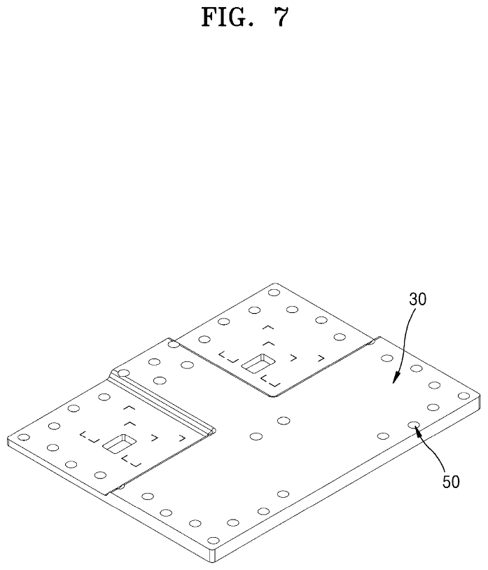

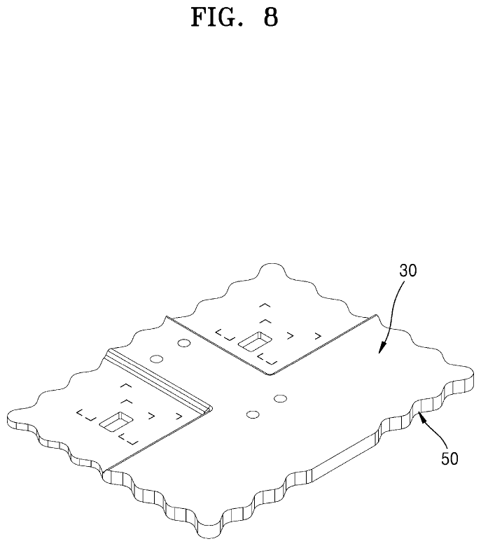

FIG. 1 shows a structure of a battery pack in which a cell holder and a bus bar are assembled according to embodiments of the present disclosure. FIG. 2 is an exploded perspective view of an assembly shown in FIG. 1 in which one bus bar is separated. FIG. 3 is a cross-sectional view cut along a line III-III in FIG. 1. FIG. 4 is a cross-sectional view cut along a line IV-IV in FIG. 1. FIG. 5 shows an example of a structure of a bus bar in FIG. 1. FIG. 6 shows another example corresponding to FIG. 5. FIG. 7 shows another example corresponding to FIG. 5. FIG. 8 shows another example corresponding to FIG. 5.

Referring to FIGS. 1 to 8, a battery pack 10 according to the present disclosure may include a battery cell 20, a bus bar 30, a cell holder 40, and a heat-conduction accelerating portion 50.

The battery cell 20 may be provided in plural. That is, a plurality of battery cells 20 may be arranged, for example, in a regular pattern in a case. The battery cell 20 may be a prismatic battery cell. The battery cell 20 may be a lithium-ion battery cell.

The bus bar 30 may be a member electrically connecting the plurality of battery cells 20. The bus bar 30 may be manufactured in various forms. The bus bar 30 may include a metal having good electric conductivity. The bus bar 30 coupled to the cell holder 40 may be provided in plural. The shapes of the plurality of bus bars 30 may be different.

The cell holder 40 may be a structure for fixing the battery cell 20 at a specific position. The cell holder 40 may also fix the bus bar 30. The cell holder 40 may be manufactured with synthetic resin. The cell holder 40 may include heat-dissipating plastic. The heat-dissipating plastic may generally include synthetic resin having superior heat conductivity. The cell holder 40 may be manufactured with, for example, polyamide, polycarbonate, polyphenylene sulfide, polybutylene terephthalate, polyether imide, etc. The cell holder 40 may be manufactured by injection molding. The bus bar 30 and the cell holder 40 may be coupled by insert-injection molding. The bus bar 30 may be prevented from moving by the cell holder 40 and maintain a stable position. The heat-conduction accelerating portion 50 may include a structure in which the bus bar 30 and the cell holder 40 are coupled by insert-injection molding.

The heat-conduction accelerating portion 50 may be a structure for accelerating heat conduction from the bus bar 30 to the cell holder 40. The heat-conduction accelerating portion 50 may include a structure for increasing a contact area between the bus bar 30 and the cell holder 40. A detailed structure of the heat-conduction accelerating portion 50 may be implemented in various forms.

The heat-conduction accelerating portion 50 may be formed in an edge portion of the bus bar 30. For example, as shown in FIG. 5, the heat-conduction accelerating portion 50 may have an edge in the form of a square wave. The heat-conduction accelerating portion 50 may increase a speed in which heat is conducted from the bus bar 30 to the cell holder 40. The heat-conduction accelerating portion 50 may also improve a coupling force between the bus bar 30 and the cell holder 40.

The heat-conduction accelerating portion 50 may include, for example, a plurality of holes as shown in FIG. 6. The holes may be formed to penetrate from a top surface to a bottom surface of the bus bar 30. If the heat-conduction accelerating portion 50 includes the plurality of holes, the plurality of holes may be arranged in a line. The plurality of holes may also be arranged in a zigzag pattern, as shown in FIG. 7.

The heat-conduction accelerating portion 50 may have, for example, an edge in the form of a sine wave, as shown in FIG. 8.

The above-described embodiments of the heat-conduction accelerating portion 50 are examples, and a structure in various forms may be included as part of the heat-conduction accelerating portion 50 to increase the speed of heat conduction in a connection portion from the bus bar 30 to the cell holder 40.

Hereinbelow, the working effects of the present disclosure will be described in detail by using, as an example, a case where heat management is made for the battery cell 20 or the bus 30 in a repetitive charging/discharging process, in the battery pack 10 including the above-described components.

The plurality of battery cells 20 of the battery pack 10 may generated heat during a charging/discharging process. The heat generated in the battery cells 20 may be transferred to the surroundings through a structures physically connected to the battery cells 20. For example, the bus bars 30 physically contact the battery cells 20, such that heat generated in the battery cells 20 may be conducted to the bus bars 30. The heat of the bus bars 30 may be transferred to the cell holder 40 physically connected to the bus bars 30. As the cell holder 40 is formed of synthetic resin, the cell holder 40 may have lower heat conductivity than that of the bus bar 30, which may be formed of metal. However, if the cell holder 40 and the bus bar 30 are coupled as the insert-injection molded structure as in the present disclosure, the contact area between the bus bar 30 and the cell holder 40 is increased. Moreover, according to the present disclosure, by including the heat-conduction accelerating portion 50, the efficiency of heat conduction from the bus bar 30 to the cell holder 40 may be significantly improved as compared to a conventional battery pack. Therefore, heat from the bus bar 30 may be quickly conducted to the cell holder 40, thereby preventing over-heating of the bus bar 30. As the cell holder 40 has a larger surface area than the bus bar 30 and a large heat capacity, the temperature of the cell holder 40 may not sharply increase within a short time due. Further, due to the large surface area of the cell holder 40, heat exchange with the surrounding air may be significant as well. Moreover, if the cell holder 40 includes heat-dissipating plastic having superior heat conductivity, the speed of heat transfer from the bus bar 30 to the cell holder 40 may further increase, thereby preventing over-heating of the bus bar 30 and the battery cell 20.

In the battery pack according to the present disclosure, the cell holder and the bus bar are integrally coupled as an insert-injection molded structure, and a coupling portion between the cell holder and the bus bar includes the heat-conduction accelerating portion, thereby quickly and effectively transferring heat from the bus bar to the cell holder structure, which has a large heat capacity. Thus, over-heating of the bus bar and the battery cell may be suppressed. Moreover, the heat transferred to the cell holder through the heat-conduction accelerating portion is exchanged with the air, thus being effectively dissipated.

Furthermore, as in the embodiments of the present disclosure, if the cell holder includes heat-dissipating plastic, heat transfer from the bus bar to the cell holder may be more effectively performed.

While the present disclosure is described by limited embodiments and drawings, the present disclosure is not limited thereby and various modifications and changes may be made by those of ordinary skill in the art within the technical spirit of the present disclosure and the equivalent range to the claims set forth below.

According to the present disclosure, the cell holder and the bus bar are integrally coupled as an insert-injection molded structure, and a coupling portion between the cell holder and the bus bar includes the heat-conduction accelerating portion, thereby quickly and effectively transferring heat of the bus bar to the cell holder structure, which has a large heat capacity and thus effectively suppressing over-heating of the bus bar and the battery cell. Moreover, the heat transferred to the cell holder through the heat-conduction accelerating portion is exchanged with the air, and, thus, the heat is effectively dissipated.

In addition, as in the embodiments of the present disclosure, if the cell holder includes heat-dissipating plastic, heat transfer from the bus bar to the cell holder may be more effectively performed.

Effects that may be obtained through the present disclosure are not limited to the above-described effects, and other technical effects not mentioned may be clearly understood by those of ordinary skill in the art from the description of the present disclosure described herein.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the present disclosure as recited in the following claims.

What is claimed is:

1. A battery pack comprising:
a bus bar electrically connecting a plurality of battery cells; and
a cell holder fixing the bus bar,
wherein the cell holder is coupled to the bus bar as an insert-injection molded structure, and
wherein the bus bar comprises a heat-conduction accelerating portion formed in a portion of the bus bar that is coupled to the cell holder.

2. The battery pack as recited in claim 1, wherein the heat-conduction accelerating portion is formed in an edge portion of the bus bar.

3. The battery pack as recited in claim 2, wherein the heat-conduction accelerating portion comprises a square pulse shaped edge.

4. The battery pack as recited in claim 2, wherein the heat-conduction accelerating portion comprises a plurality of holes extending between a top surface and a bottom surface of the bus bar.

5. The battery pack as recited in claim 4, wherein the plurality of holes are arranged in a line.

6. The battery pack as recited in claim 4, wherein the plurality of holes are arranged in a zigzag pattern.

7. The battery pack as recited in claim 2, wherein the heat-conduction accelerating portion comprises a sine wave shaped edge.

8. The battery pack as recited in claim 1, wherein the cell holder comprises a heat-dissipating plastic.

9. A battery pack comprising:
a bus bar electrically connecting a plurality of battery cells; and
a cell holder fixing the bus bar,
wherein the cell holder is coupled to the bus bar, and
wherein the bus bar comprises a heat-conduction accelerating portion formed in a portion of the bus bar that is coupled to the cell holder.

10. The battery pack as claimed in claim 9, wherein the heat-conduction accelerating portion is formed in an edge portion of the bus bar.

11. The battery pack as claimed in claim 10, wherein the heat-conduction accelerating portion comprises a square pulse shaped edge.

12. The battery pack as claimed in claim 10, wherein the heat-conduction accelerating portion comprises a plurality of holes extending between a top surface and a bottom surface of the bus bar.

13. The battery pack as claimed in claim 12, wherein the plurality of holes are arranged in a line.

14. The battery pack as claimed in claim 12, wherein the plurality of holes are arranged in a zigzag pattern.

15. The battery pack as claimed in claim 10, wherein the heat-conduction accelerating portion comprises a sine wave shaped edge.

16. The battery pack as claimed in claim 9, wherein the cell holder comprises a heat-dissipating plastic.
